(19) United States
(12) Patent Application Publication
(10) Pub. No.: US 2007/0248252 A1
(43) Pub. Date: Oct. 25, 2007

(54) Method for monitoring during an image-based clinical study

(76) Inventors: Sylvia Heywang-Kobrunner, Baldham (DE); Markus Schmidt, Nurnberg (DE); Ulrike Schwarz-Boeger, Munchen (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 11/785,270

(22) Filed: Apr. 17, 2007

(30) Foreign Application Priority Data
Apr. 18, 2006 (DE) 10 2006 017 839.4

(51) Int. Cl. G06K 9/00

(52) U.S. Cl. 382/128

(57) ABSTRACT

A method is disclosed for monitoring during an image-based clinical study. In at least one embodiment, in the method medical image data are produced from a patient to present a medical diagnosis and verification data correlated with the diagnosis are collected from the patient to verify the diagnosis. Further, the diagnosis verified with the aid of the verification data is stored inseparably together with the image data as medical reference image data and the image data, of at least two investigating staff, are presented to extract respective individual information. Further, the respective individual information is stored inseparably together with the image data in respective reader data and the respective reader data are presented to a study monitor for monitoring.

### PRIORITY STATEMENT

The present application hereby claims priority under 35 U.S.C. §119 on German patent application number DE 10 2006 017 839.4 filed Apr. 18, 2006, the entire contents of which is hereby incorporated herein by reference.

### FIELD

Embodiments of the invention generally relate to a method for monitoring during an image-based clinical study.

### BACKGROUND

Imaging methods are being introduced more and more into everyday medical practice. This applies to all areas of medicine, such as medical practices, hospitals or even mobile units for example in an ambulance. Consequently, more and more images are available for an individual patient owing to the continuously increasing imaging methods and/or image medical devices.

Since imaging methods currently operate digitally as a rule, the images are usually available as computer readable data, for example, in the form of an image file. Even images in originally analog form, for example an X-ray film or a paper printout of an ultrasonic image, can be appropriately digitized.

The evaluation of medical image data, for example an interpretation thereof, the preparation of a diagnosis or similar, by a reader, for example a doctor, is a very complex procedure that requires human experience and the capacity to judge. Since the interpretation and, in particular, the taking of a medical decision, for example the selection of a course of treatment, on the basis of image data is therefore subject to error, there are so called “gold standard” methods for backing up a diagnosis presented by the doctor on the basis of image data. In the case of a cancer diagnosis, it is, for example, the taking of a histopathological sample of the patient at the site correspondingly diagnosed in the medical image. Another method is, for example, a genetic test on a patient. These gold standard methods supply information in the form of a generally written report that has, in turn, been prepared by a human expert or an algorithm.

Consequently, the German patent application submitted on the same data and which goes back to the same inventor discloses medical reference data and a method for producing them in order to attain liability of diagnosis with reference to a diagnosis prepared on the basis of image data. Specifically, both the image data on which the diagnosis is based, and the diagnosis backed up by the collection of gold standard information are stored inseparably together in a data record, specifically the medical reference data.

Owing to the abovementioned multiplicity of medical images that are available for a patient, it has also become desirable recently to carry out clinical studies on the basis of medical image data and/or images. The images are generally presented here independently of one another to various readers, each reader evaluating the image presented to him. For example, he examines the image with reference to diagnosable tumors and so doing estimates the tumor diameter. Thus, study data collected in accordance with the individual readers are then monitored and/or evaluated by a further person, a so called monitor.

There is the problem here that the evaluation by the monitor is extremely difficult, since the latter cannot replicate how the individual reader reaches his personal study data, specifically by the image reading. Thus, the monitor is, for example, unable to duplicate which image region has been judged by the individual reader to be an ROI (Region of Interest), how the latter has arrived at the tumor diameter, etc. The verification of the study data determined by the readers can thus be checked only with the aid of variables derived from the image data, but not with the aid of the image data themselves. This was easily possible in prior medical studies not supported by images since, for example, it was possible to test against data in a patient file. In the present case, however, it is mostly only the corresponding image of the patient that exists.

The corresponding problems can be solved currently solely by having a committee of experts take a fundamental decision with reference to the ROIs and their like in medical image data.

### SUMMARY

In at least one embodiment, the present invention specifies an improved method for carrying out an image-based clinical study.

On the basis of the above named patent application, structured information such as, for example, a diagnosis or a found location, that is to say the situation of the ROI and other parameters are stored in medical reference image data in the course of the method. Thus, what happens here is an appropriate linking of the image information of the image data to the additional information in accordance with the gold standard in order to confirm a diagnosis prepared with the aid of the image data.

In the courses of the clinical study, a number of investigating staff, also termed “readers” in a technical jargon and termed so below for the sake of simplicity, are then presented anew with the image data independently of one another. Each reader in this case extracts his individual information from image data on his own independently of the others. Such information can also be, for example, a diagnosis including found location. Again, each reader stores the image data together with his information extracted from the image data, doing so inseparably together in the respective reader data.

These reader data are then presented to the monitor of the clinical study. Since each reader files his information inseparably in the reader data, the monitor is capable of duplicating how and, for example, with the aid of which found site the individual reader has arrived at his information, for example a finding in the image. The monitor thereby has a possibility of actually reliably comparing with one another the respective image evaluations of the individual image readers.

The individual readers generally obtain the image data only on their own and anonymously, that is to say without reference to a patient or background information referring to the image data. By contrast, depending on the study the monitor has this background information, that is to say the reference image data, available. However, it is possible here, as well, that the monitor, too, obtains only the information, that is to say results of the individual image readers, without any sort of background information, that is to say without access to the reference image data.

The study monitor can thus additionally present the reference image data. Through the reference image data, the study monitor obtains reliable statements on the actual, that is to say diagnostic and reliable finding of the image data. He can therefore test the reader data additionally against the reference image data.

If at least a portion of the verification data is also stored in the reference image data, the study monitor has available, moreover, not only the backed up diagnosis, but also the corresponding supporting gold standard information from the verification data in order also to incorporate these, if appropriate, when evaluating the individual reader data.

The found site can be stored as image information in the image data, both in the reference image data and in the reader data. The monitor need not then firstly, for example evaluate coordinate information on the found site, but sees at a glance how this is marked in the image data.

In order also to be able to better delimit the ROI with reference to its extent, a region marker for a subregion of the image data can be stored as found site.

This region marker is particularly well visible when it is stored in the image data as an optical accentuation of the subregion, in particular as a borderline around the subregion.

Before the image data are presented to the investigating staff, that is to say readers, the image data or images can be preprocessed, for example with the aid of suitable methods and/or algorithms of image processing. The preprocessing can also be performed here automatically. Thus, the image data can be conditioned by the reader for the extraction of information.

Again, the respective reader data can be preprocessed to form a result image that is presented to the study monitor. The study monitor need not then consider all the reader data and the reference data individually, next to one another or successively, but obtains a result image that includes, for example, all the ROIs of the individual readers, and the ROIs of the reference image data. The comparison of the results (ROT, findings) of the individual readers then turns out to be particularly simple through the consideration of a single result image.

The differences between found sites and/or diagnoses of individual reader data can also be optically accentuated in the result image. Discrepancies between individual readers and/or their results are thus visualized in a particularly striking fashion for the study monitor.

Depending on the evaluation of the reader data by the study monitor, that is to say the monitoring, it is possible to take suitable measures during the clinical study. This renders possible a particularly effective control of the clinical study with reference to avoidance of error, study quality, etc.

As a suitable measure the image data can be presented once more to a reader for the purpose of presenting an individual diagnosis. In the case, for example, of strongly deviating reader results, it is thereby possible to achieve a more reliable statistical evaluation of the clinical study by increasing the number of readers.

If, for example, the monitor establishes no solid deviations or only deviations within the scale of statistical fluctuations between reader data, he can correspondingly release study results as a measure.

### BRIEF DESCRIPTION OF THE DRAWINGS

Reference is made to the example embodiments of the drawing for a further description of the invention. In a schematic sketch:

FIG. 1 shows a sequence diagram of the monitoring for an image-based clinical study.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the term “and/or” includes any and all combinations of one or more of the associated listed items.

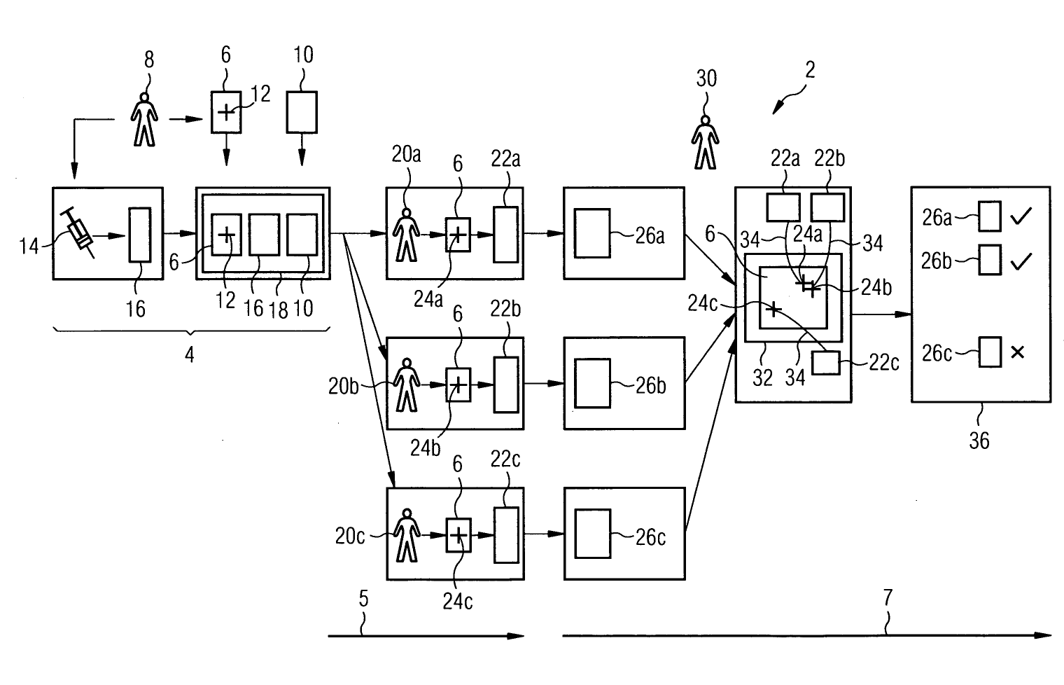

FIG. 1 shows a segment from the evaluating process 2 of a clinical study. The process is divided into a preparatory step 4, an evaluation phase 5 and a monitoring phase 7.

In the preparatory step 4, an X-ray image 6 of a patient 8 is prepared and a diagnosis 10, relating to the patient 8 and/or the X-ray image 6, is prepared with the aid of the X-ray image 6 by a committee of experts (not illustrated). In order to confirm the diagnosis 10, specifically a finding of a tumor on the patient 8, in the example, a biopsy is taken at the corresponding found site 12 in the x-ray image 6, represented in FIG. 1 by a reticle, the biopsy being illustrated in FIG. 1 by a biopsy needle 14.

The biopsy constitutes a gold standard method for backing up the diagnosis 10, and it confirms the diagnosis 10 with absolute certainty at the found site 12. The biopsy leads to a biopsy report 16 that is stored in a reference data record 18 together with the X-ray image 6, the found site 12 and the diagnosis 10. The reference data record therefore includes all reliably verified findings data of the patient 8.

In the evaluation phase 5, three different radiologists 20a-c are respectively presented independently of one another in the course of the clinical study with the X-ray image 6 for reading and making findings. Each of the radiologists 20a-c now determines for himself in the X-ray image 6 an individual diagnosis 22a-c at an individual found site 24a-c. The radiologists 20a-c have no access here to the data record 18, and thus do not know the diagnosis 10 verified at the found site 12 by the committee of experts. Since the clinical study is carried out anonymously, the radiologists 20a-c also obtain no additional information referring to the patient 8. The evaluation phase 5 of the clinical study is thereby concluded.

In the monitoring phase 7, a monitor 30 monitors the diagnoses 22a-c and found sites 24a-c prepared by the radiologists 20a-c. These diagnoses and found sites have respectively been jointly combined in a corresponding reader data record 26a-c. In order to enable the monitor 30 to conduct this comparison or to simplify it, all the reader data records 26a-c are combined visually in a reader image 32. The latter includes the X-ray image 6 in which all three found sites 24a-c are combined with the associated diagnoses 22a-c. The correspondence between the found sites 24a-c and the diagnoses 22a-c is produced in the reader image 32 by connecting lines 34.

The monitor 30 recognizes that the found sites 24a-b lie closely next to one another and the found site 24c lies in another region of the X-ray image 6. By comparing with the reference data record 18, monitor 30 establishes furthermore that the found sites 24a, b together with the diagnoses 22a, b agree with the found site 12, confirmed in accordance with the gold standard, and the diagnosis 10.

The reader data record 26c is therefore demonstrably false and can be ruled out for further use in the clinical study. This is prompted by the monitor 30 in the release step 36 of the clinical study. By contrast, the reader data records 26a, b are released for the study. Since, however, it is prescribed in the study protocol of the clinical study to produce at least three reader data records, in the release step 36 the monitor 30 furthermore prompts the X-ray image 6 to be placed once again for the purpose of finding before a reader (not illustrated) corresponding to the readers 20a-c, in order to produce a further reader data record in accordance with the data records 26a and b.

In the above described alternative, the monitor 30 has been shown all the found sites 24a-c in the reader image 32. Alternatively, it is also possible to compare the found sites 24a-c in advance, for example by methods of image processing, whereupon the monitor 30 is shown only the deviated found site 24c. The found sites 24a, b lie within a tolerance range in the region of the found site 12, and are therefore declared valid in advance and not shown to the monitor 30.

The attentiveness of the monitor 30 to the found site 24c deviating from the confirmed finding is thereby heightened.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for monitoring during an image-based clinical study, the method comprising:
producing medical image data from a patient to present a medical diagnosis;
collecting verification data, correlated with the diagnosis, from the patient to verify the diagnosis;
storing the diagnosis, verified with the aid of the verification data inseparably together with the image data as medical reference image data;
presenting the image data, of at least two investigating staff, in order to extract respective individual information;
storing the respective individual information inseparably together with the image data in respective reader data; and
presenting the respective reader data to a study monitor for monitoring.

2. The method as claimed in claim 1, wherein the investigating staff extract information with the aid of an individual found site in the image data, and the respective found site is stored in the reader data.

3. The method as claimed in claim 1, wherein the investigating staff extract a diagnosis as information from the image data.

4. The method as claimed in claim 1, wherein additionally the reference image data are presented for monitoring to the study monitor.

5. The method as claimed in claim 1, wherein at least a portion of the verification data is stored in the reference image data.

6. The method as claimed in claim 2, wherein the found site is stored as image information in the image data.

7. The method as claimed in claim 6, wherein a region marker for a subregion of the image data is stored as found site.

8. The method as claimed in claim 7, wherein an optical accentuation of the subregion, in particular a borderline around the subregion, is stored as region marker.

9. The method as claimed in claim 1, wherein the image data are preprocessed before being presented to the investigating staff.

10. The method as claimed in claim 1, wherein the respective reader data are preprocessed to form a result image that is presented to the study monitor.

11. The method as claimed in claim 10, wherein the differences between information of individual reader data are optically accentuated in the result image.

12. The method as claimed in claim 1, wherein suitable measures are taken during the clinical study as a function of the monitoring of the reader data by the study monitor.

13. The method as claimed in claim 12, wherein, as a suitable measure, the image data are presented once more to an investigating staff member for extracting an individual information item.

14. The method as claimed in claim 2, wherein the investigating staff extract a diagnosis as information from the image data.

15. The method as claimed in claim 8, wherein the optical accentuation of the subregion is a borderline around the subregion.

16. A computer readable medium including program segments for, when executed on a computer device, causing the computer device to implement the method of claim 1.
